(19) United States
(12) Patent Application Publication
(10) Pub. No.: US 2011/0239453 A1
(43) Pub. Date: Oct. 6, 2011

(54) Method and a device for aligning the overlapping ends of metal strips

(75) Inventor: Dipl-Ing Hans-Ulrich Fritz, Stuttgart (DE)

(73) Assignee: ACI ecoTec GmbH, Zimmern o.R. (DE)

(21) Appl. No.: 13/133,418

(22) PCT Filed: Jul. 24, 2009
(86) PCT No.: PCT/EP2009/005373

§ 371 Date: Jun. 8, 2011

(30) Foreign Application Priority Data
Dec. 11, 2008 (DE) 10 2008 063 506.5

(51) Int. Cl. H01R 43/00; B23P 19/00

(52) U.S. Cl. 29/825; 29/745

(57) ABSTRACT

The invention relates to a device for aligning overlapping ends of metal strips, particularly contact bands for photovoltaic solar cells, wherein the end of one of the metal strips is bent back. The device has an advance, displaceable first alignment element for aligning the upper end of one metal strip and a trailing, displaceable second alignment element for aligning the bent end of the other metal strip, and a contact element for the first alignment element and a contact element for the second alignment element. In this manner, a rapid and simple mechanical automated alignment of the overlapping ends of metal is made possible.

The present invention relates to a method and a device for aligning the overlapping ends of metal strips in accordance with the preambles of claim 1 and of claim 6.

In manufacturing photovoltaic solar cells, individual photovoltaic solar cells are connected in series. For this purpose, the solar cells are furnished with, for example, two parallel, longitudinally aligned metal strips that use conductive adhesive beads, which constitute both electrical poles and are connected at one end to metal contact strips whose free ends form the connection contacts. These metal strips are attached in accordance with DE 10 2007 016 386 A1 with the interposition of an insulation strip, whereby the free end of one metal strip is bent back and the end of the other metal strip is placed over the aforementioned bent-back end (DE 10 2007 016 386 A1). Then these free ends must be aligned in order to be able to thread them through a transparent element covering the solar cells.

The objective of the present invention is to create a method and a device for aligning the overlapping ends of metal strips of the type mentioned above, so as to make possible a rapid and simple aligning process that is also mechanically automated.

To achieve this objective, the features cited in claim 1 are provided with regard to a method of the aforementioned type, and the features cited in claim 6 are provided with regard to a device of the aforementioned type.

The measures according to the present invention ensure that the free ends of both metal strips can be aligned one after the other simply and automatically. In this context, a free end is aligned against a contact element so that the aligned free end attains a predetermined and always identical position.

Advantageous embodiments of the method can be derived from the features of one or more of claims 2 to 5. On the one hand, a simplification of the method is achieved in that the free end of one metal strip is pressed against the back of the first contact element, and the free end of the other metal step is pressed against the back of the trailing aligning element. After the release of the aligned free ends, they can easily spring back, adopting their essentially precise vertical position, which can then be detected by a sensor arrangement.

Advantageous embodiments of the contact element of the device can be derived from the features of one or more of claims 7 to 9. In this context, the first contact element is provided with the aligning edge and the appropriately inclined rear contact surface for the aligned free end of one metal strip. The slope of the rear contact surface may be adjusted.

Advantageous embodiments of the second contact element can be derived from the features of claim 10 and/or 11.

The two aligning elements in accordance with the features of one or more of claims 12 to 20, on the one hand, are movable in linear fashion and, on the other hand, can pivot in order to align the free ends so as to place them on the relevant contact element in opposition to the force of a spring, so that it becomes simple to grasp and align the free ends.

Further details of the invention may be derived from the following description, in which the invention is described and discussed in greater detail on the basis of the exemplary embodiment depicted in the drawing. In the drawing:

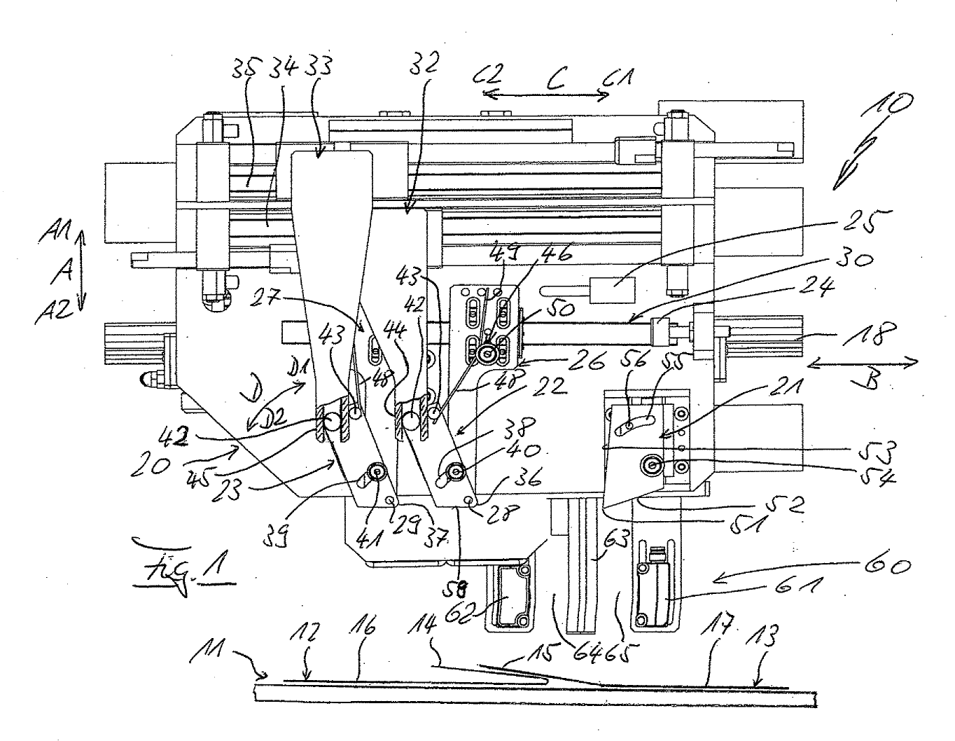

FIG. 1 depicts a device for aligning the overlapping ends of metal strips in a side view and in an initial position in accordance with a preferred exemplary embodiment of the present invention, and

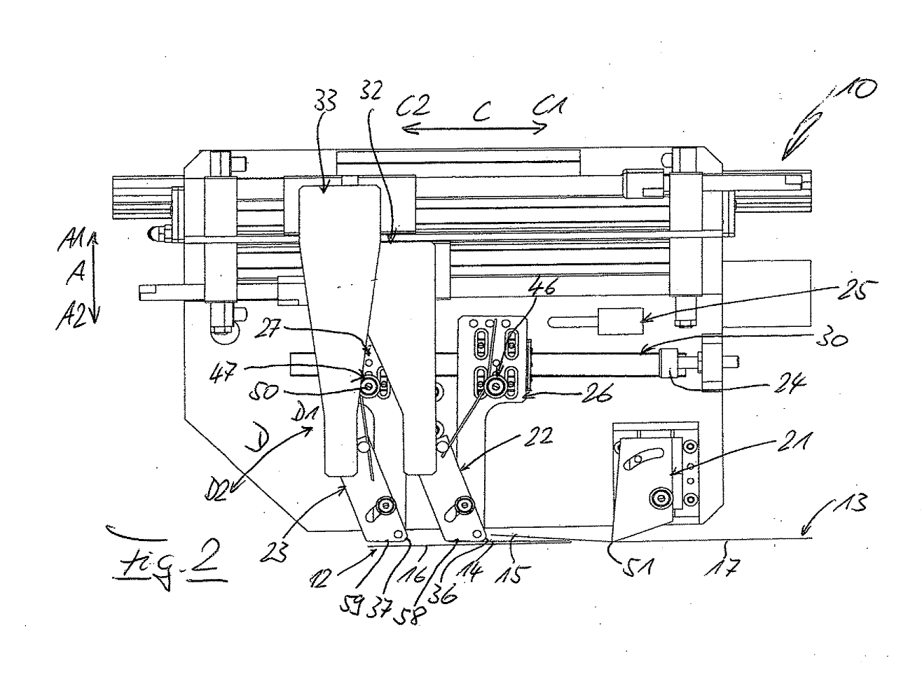

FIGS. 2 to 5 depict views in accordance with FIG. 1, but with regard to various method steps involved in aligning the overlapping ends of metal strips.

Device 10, depicted in FIG. 1, aligns the overlapping free ends of preferably metal strips, in particular free ends 14, 15 of contact strips 12, 13, as used, for example, in thin-film solar cells 11 as connections that lead to adjacent solar cells 11. In solar cell 11, as depicted in FIG. 1, free end 14 of one contact strip 12 is bent back, whereby it is arranged at an acute angle with respect to strip part 16 of contact strip 12 that is attached to solar cell 11, whereas free end 15 of other contact strip 13 is arranged at an obtuse angle with respect to strip part 17 of contact strip 13 that is attached to solar cell 11, such that it also runs at an acute angle with respect to strip part 16 of contact strip 12, over the latter's bent-back free end 14. Bent-back free end 14 and free end 15 have the same length; because individual bent edges of ends 14, are arranged at a distance on solar cell 11, ends 14, 15 do not overlap, or cover each other, completely. Both bent-back free ends 14, 15 must be aligned for the subsequent use and interconnection of solar cells 11 so as to form a solar module, and they are threaded through a cover element for solar cell 11 or the solar module.

Device 10 as depicted in FIG. 1 has a vertical base plate 20, which can be moved back and forth in the vertical direction as depicted by double arrow A and which, in an undepicted manner, can be moved back and forth over a horizontal arm along a rail 18 in accordance with double arrow B and can be arrested in any desired position, for example by clamping. Arranged on base plate 20 are a first contact element 21, a first aligning element 22 which simultaneously acts as a second contact element, and a second aligning element 23. Whereas first contact element 21 is supported fixedly on base plate 20, both aligning elements 22, 23 can move in the direction of double arrow C relative to and on base plate 20. As will be shown below, in the aligning process for free strip ends 14, 15, first aligning element 22 moves so as to lead in direction C1 towards first contact element 21, while second aligning element 23 moves so as to trail in this direction. The aligning motion of both aligning elements 22, 23 is direction C1 towards first contact element 21.

Aligning elements 22, 23 are supported so that they can pivot about axes 28, 29 at the lower free ends of lever arms 26, 27, respectively, which can move along a horizontal guide bar 30 in accordance with double arrow C. Guide bar 30 at its fixed end has a limit stop 24, which can be horizontally adjusted, for example as an adjusting screw, for lever arm 26, which leads in direction C1, and it has a second limit stop 25, which also can be adjusted horizontally and which additionally is arranged on base plate 20 so as to be offset horizontally and vertically, for lever arm 27, which trails in direction C1.

Aligning elements 22 and 23 are each influenced by an actuator 32, 33, whereby each actuator 32, 33 is driven so that it can move back and forth in accordance with double arrow C over a separate guide element, for example a guide spindle 34, 35, respectively. Actuators 32, 33 may be driven independently of each other. The driven motion of both actuators 32, 33 is transmitted in both directions C1, C2 to lever arms 26, 27 via aligning elements 22, 23, respectively.

Aligning elements 22, 23 are constructed essentially identically, i.e., they are configured so as to be roughly parallelogram-shaped and their pivot axes 28, 29 are situated close to their lower aligning edge 36, 37. Their pivot motion in the direction of double arrow D is guided and limited by a longitudinal hole 38, 39, whose central point is pivot axis 28, 29 and through which a bolt 40, 41 that is attached to lever arm 26, 27, respectively, is inserted. Actuator 32, 33 engages at its fork-shaped free end 44, 45 with an actuator pin 42 of aligning element 32, 33 that is facing away from pivot axis 28, 29. Aligning element 32, 33 is also provided with a contact pin 43 that is arranged so as also to be facing away from pivot axis 28, 29, at which a long end, or leg 48, of a leg spring 46, 47 makes contact in a pre-stressed manner, whose other long end, or leg 49, contacts a contact pin in a pre-stressed manner on the other side of a leg-spring attachment 50 on lever arm 26, 27.

First contact element 21, which has an aligning, i.e., bending edge 51, whose surfaces 52, 53, which constitute it, form an acute angle with each other, is supported so that it can be adjusted in pivoting fashion about an axis 54 on base plate 20, whereby a circular longitudinal hole 55 that is facing away from axis 54 is provided, whose central point is axis 54 and through which a guide bolt 56 is inserted.

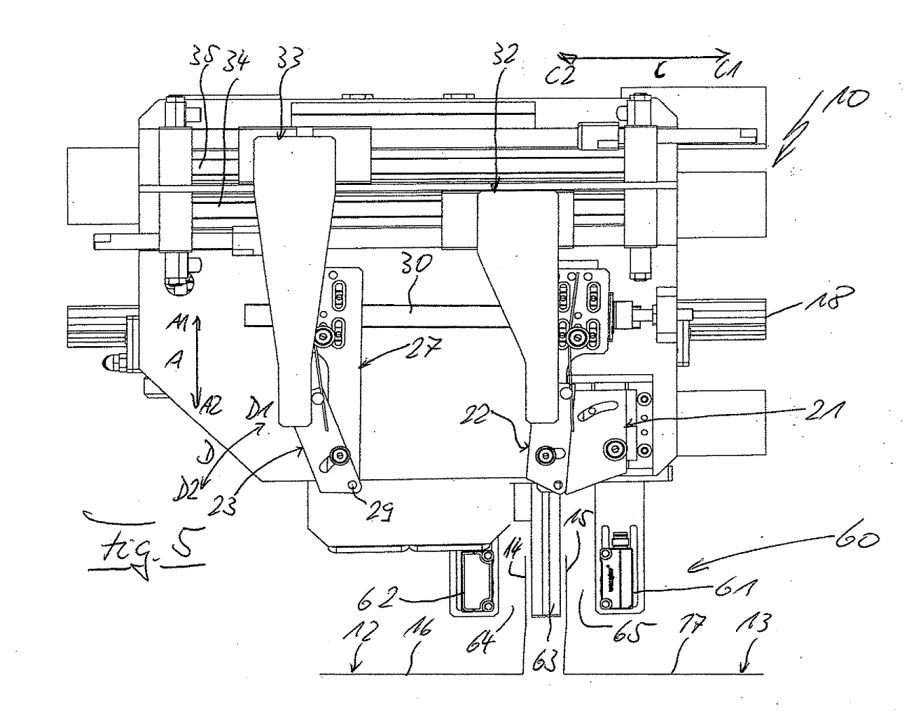

FIG. 1 also depicts a sensor arrangement 60, in its initial position, which has two sensors 61, 62, between which an intermediate wall 63 is arranged, thus creating two sensor spaces 64, 65. Sensor arrangement 60 in accordance with FIG. 1 is situated in a plane that lies behind the plane of base plate 20, so that sensor arrangement 60 is effective and detects aligned free ends 14, 15 when, as will be depicted below, base plate 20 having the aforementioned elements is situated in the initial position in accordance with FIGS. 1 and 5 and not in one of the working positions for alignment processes in accordance with FIGS. 2 to 4.

In the following, on the basis of FIGS. 2 to 5, the individual steps are described for aligning overlapping free ends 14, 15 of contact strips 12, 13.

According to FIG. 2, proceeding from the upper, or initial position of FIG. 1, base plate 20 in vertical direction A2 is brought over contact strips 12, 13, whereby first aligning element 22 is brought onto the area of free end 14 of contact strip 12 that overlaps free end 15 of contact strip 13. As mentioned above, both free ends 14, 15 run at an acute angle of, for example, approximately 3° to the horizontal and are approximately parallel to each other, whereby end 15 only partially covers bent-back end 14. According to FIG. 2, lower surface 58 of first aligning element 22 sits upon this area of free end 14 that overlaps end 15 and therefore is accessible from above in such a way that free end 14 moves while its angle to strip part 16 of contact strip 12 becomes smaller. Therefore, aligning edge 36, which here is rounded, of first aligning element 22 is situated beneath the edge of free end 15 of contact strip 13, which is to be aligned. In this position, aligning/bending edge 51 of first contact element 21 is located at a bending area of strip part 17 with respect to its sloped free end 15.

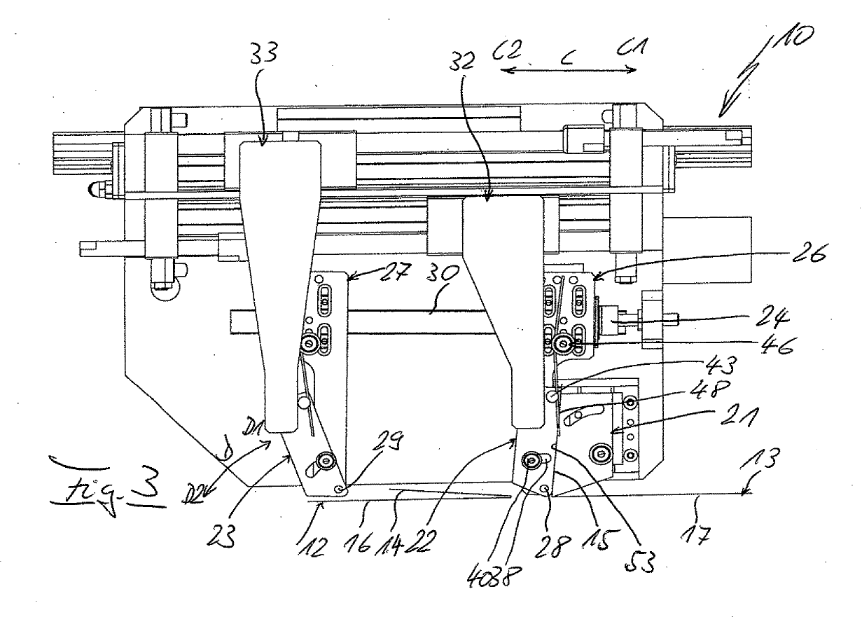

Actuator 32 moves first aligning element 22 in the direction of arrow C1, whereby aligning edge 36 of first aligning element 22 engages underneath free end 15 of contact strip 13 and aligns free end 15 about the aligning/bending edge of first contact element 21, whereby free end 15 moves along the front side of first aligning element 22. As soon as aligning edge 36 of leading first aligning element 22 approaches contact surface 53 of first contact element 21 and simultaneously lever arm 26 contacts end limit stop 24, first aligning element 22 pivots due to the further motion of actuator 32 about its pivot axis 28 in the direction of arrow D1 until the front side of first aligning element 22, with first end 15 acting as an intermediate layer, makes contact against rear surface 53 of first contact element 21. This state is depicted in FIG. 3.

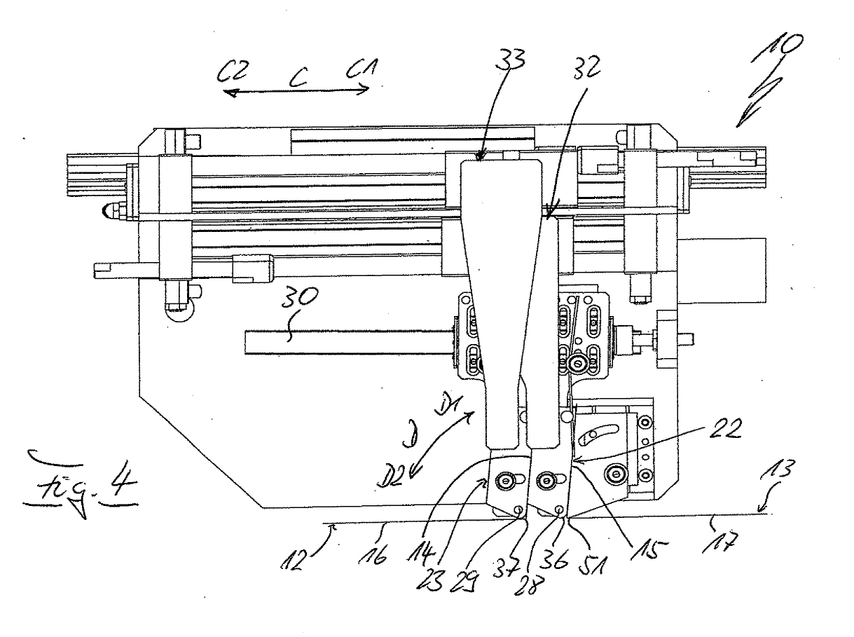

Then, trailing second aligning element 23 at second lever arm 27 is moved by actuator 33 in the direction of arrow C1, whereby lower surface 59 of second aligning element 23 is situated close to the upper side of strip part 16. As a result, aligning edge 37, which here is rounded, of second aligning element 23 can engage beneath bent-back free end 14 of contact strip 12, and it can align free end 14. In the slanted position depicted in FIG. 3, second aligning element 23 moves in the direction of arrow C1 until it approaches the rear surface of first aligning element 22 and, simultaneously, lever arm 27 makes contact at end limit stop 25. Thereupon, actuator 33, which continues in motion, pivots second aligning element 23 in the direction of arrow D1, i.e., second aligning element 23 is pivoted about its pivot axis 29 until its front side contacts the rear surface of first aligning element 23, with free end 14 of contact strip 12 acting as an intermediate layer. In this way, first aligning element 23 simultaneously acts as a second contact element for free end 14 and second aligning element 23. This concludes the motion in the direction of arrow C1 of actuator 33. This position is shown in FIG. 4. From it can be seen that free ends 14, 15 of both contact strips 12, 13 are aligned to form an angle of somewhat less than 90° with strip part 16, 17 of contact strip 12, 13. It is obvious that this obtuse-angled position may be adjusted by adjusting first contact element 21.

Then second aligning element 23 is first moved back into its initial position in the direction of arrow C2, as is depicted in FIG. 5, a reverse motion that is caused by the entrainment connection of fork-end 45 of actuator 33 and actuator pin 42 on second aligning element 23, as is depicted only in FIG. 1.

Then base plate 20 is moved upwards in the direction of arrow A1, so that aligned free ends 14, 15 of both contact strips 12, 13 are released both from the rear of first aligning element 22 as well as from the space between the front side of first aligning element 22 and rear side 53 of first contact element 21. In this context, depending on the type and thickness of the metal, both free ends 14, 15 spring back into their essentially perpendicular position with respect to strip parts 16, 17 of contact strips 12, 13. In this initial position of base plate 20, pulled upwards, aligned free ends 14, 15 reach the area of sensor arrangement 60 as a result of the fact that solar cell 11 is moved perpendicularly to the sheet plane, and that both free ends 14, 15 reach spaces 64, 65 of sensor arrangement 60, which can determine whether the free ends have attained their predetermined aligned position.

In accordance with the state depicted in FIG. 5, first aligning element 22 in accordance with arrow C2 is returned to the initial position as depicted in FIG. 1. Both with respect to second aligning element 23 as well as first aligning element 22, the return motion in accordance with arrow C2, based on the action of leg springs 46, 47 and the location of the motion connection of actuators 32, 33 and aligning elements 22, 23, causes the latter to take on their original slanted position, bent in the direction of arrow C2.

During this, solar cell 11 having aligned free ends 14, 15 of contact 12, 13 can be transported from device 10.

1-21. (canceled)

22. A method for aligning the overlapping ends of metal strips, in particular contact strips on photovoltaic solar cells, comprising the steps of:
bending back the end of one of the metal strips, so that the end of one metal strip, situated on top, and the bent back end of the other metal strip are aligned;
placing said end of one metal strip situated on top against a first contact element; and then
placing the end of the other metal strip against a second contact element.

23. The method as recited in claim 22, wherein:
said end of one metal strip situated on top is aligned at and around an edge of said first contact element and is placed against a rear side of said first contact element.

24. The method as recited in claim 22, wherein:
said bent back end of the other metal strip (12) is placed against a rear side of said second contact element.

25. The method as recited in claim 22, wherein:
the ends of both metal strips, as they are aligned, are bent into an intermediate position that exceeds the aligned position by a few degrees, from which both metal strips spring back into their aligned position after being released.

26. The method as recited in claim 22, wherein:
the aligned ends of the two metal strips are detected by sensors.

27. A device for aligning the overlapping ends of metal strips, in particular contact strips on photovoltaic solar cells, whereby the end of one of the metal strips is bent back, comprising:
a leading first aligning element for aligning the upper end of one metal strip and
a trailing second aligning element for aligning the bent-back end of the other metal strip; and
a contact element for the first aligning element as well as a contact element for the second aligning element.

28. The device as recited in claim 27, wherein:
said first contact element is provided with an aligning edge for the upper end of one metal strip.

29. The device as recited in claim 27, wherein:
said first contact element is provided with a rear contact surface that is preferably angled with respect to the vertical for the aligned upper end of one metal strip.

30. The device as recited in claim 27, wherein:
said first contact element may be adjusted in its slope about a pivot axis.

31. The device as recited in claim 27, wherein:
said contact element for the trailing second aligning element is formed by the first aligning element.

32. The device as recited in claim 31, wherein:
said first aligning element is provided with a contact front side for the upper end, to be aligned or aligned, of one metal strip and with a rear contact surface for the aligned bent-back end of the other metal strip.

33. The device as recited in claim 27, wherein:
said two aligning elements can move in linear fashion and can pivot about a pivot axis that is arranged perpendicular thereto.

34. The device as recited in claim 33, wherein:
said pivot axis is arranged so as to adjoin an aligning edge of the aligning element, respectively.

35. The device as recited in claim 27, wherein:
said aligning element is acted upon and moved by an actuator, which can move relative to said aligning element in the direction of the aligning motion.

36. The device as recited in claim 34, wherein:
said aligning element can be pivoted in the direction of the aligning motion at a lever arm in opposition to a spring force.

37. The device as recited in claim 36, wherein:
the spring force is provided by a leg spring, whose one pre-stressed end contacts said aligning element facing away from said pivot axis and whose other pre-stressed end is fixed at the lever arm that is movably supported.

38. The device as recited in claim 27, wherein:
said actuators are movably supported on parallel guide rails so as to be driven preferably separately.

39. The device as recited in claim 27, wherein:
said lever arms are movably supported on a common guide rail.

40. The device as recited in claim 27, wherein:
said lever arms are driven by individually assigned actuators via the relevant aligning element.

41. The device as recited in claim 27, wherein:
an adjustable motion end stop is assigned to each lever arm.

42. The device as recited in claim 27, wherein:
said actuators, said aligning elements, and said contact element are supported on a base plate, which can move vertically relative to a sensor arrangement which detects the aligned ends of the metal strips.
